(19) United States
(12) Patent Application Publication
(10) Pub. No.: US 2005/0098480 A1
(43) Pub. Date: May 12, 2005

(54) Hydrotreating catalyst and method

(76) Inventors: Robert Galiasso, San Antonio De Los Altos (VE); Gerardo Arreaza, Caracas (VE); Samuel Quenza, Edo Araqua (VE); Sandra Ramnarine, Caracas (VE)

Correspondence Address: BACHMAN & LAPOINTE, P.C., 900 CHAPEL STREET, SUITE 1201, NEW HAVEN, CT, 06510, US

(21) Appl. No.: 10/712,827

(22) Filed: Nov. 12, 2003

(51) Int. Cl. C10G 45/04; B01J 27/14; B01J 27/186; B01J 27/187; B01J 27/199; C10G 25/00; C10G 45/60; B01J 21/08; B01J 21/12; B01J 21/14; B01J 23/00

(52) U.S. Cl. 208/213; 208/216 R; 208/216 PP; 208/217; 502/263; 502/325; 502/305; 502/321; 502/208; 502/337

(57) ABSTRACT

A method is provided for hydrofeeding a diesel feedstock, which method includes the steps of providing a feedstock containing a Diesel feed fraction and sulfur; and feeding the feedstock to a hydrotreating reactor containing a catalyst selective toward Cetane Index improving reactions and hydrodesulfurization reactions so as to provide a product stream containing an improved Diesel fraction having an increased Cetane Index as compared to the Diesel Feed fraction, wherein the catalyst is substantially resistant to sulfur deactivation.

### BACKGROUND OF THE INVENTION

The invention relates to a hydrotreatment method and catalyst and, more particularly, to a sulfur resistant catalyst which retains sulfur resistance at high temperature and is therefore suitable for use in various hydrotreating processes.

Hydrocarbons are treated utilizing numerous processes so as to obtain various desirable end products. Catalysts are frequently used to encourage desirable reactions and thereby gain larger fractions of desired end products.

Catalysts are frequently sensitive to certain contaminants contained in the feed, and two contaminants which frequently cause problems are sulfur and nitrogen.

Various catalysts have been provided and have resistance to sulfur, nitrogen and the like. Unfortunately these catalysts tend to be more susceptible at higher temperatures.

The need therefore remains for a catalyst which is resistant to sulfur and other contaminant deactivation at elevated temperatures.

It is therefore the primary object of the present invention to provide such a catalyst.

It is a further object of the present invention to provide a hydrotreatment method using such a catalyst.

Other objects and advantages will appear hereinbelow.

### SUMMARY OF THE INVENTION

In accordance with the present invention, the foregoing objects and advantages have been readily attained.

According to the invention, a method is provided for hydrotreating a diesel feedstock, which method comprises the steps of providing a feedstock containing a Diesel feed fraction and sulfur; and feeding said feedstock to a hydrotreating reactor containing a catalyst selective toward Cetane Index improving reactions and hydrodesulfurization reactions so as to provide a product stream containing an improved Diesel fraction having an increased Cetane Index as compared to said Diesel Feed fraction, wherein said catalyst is substantially resistant to sulfur deactivation.

Still further according to the invention, a sulfur resistant catalyst is provided which comprises a base selected from the group consisting of alumina, aluminosilicate and combinations thereof, and at least one metal selected from the group consisting of nickel, tungsten, molybdenum, palladium, phosphorous and mixtures thereof, wherein said catalyst is substantially resistant to sulfur deactivation.

### BRIEF DESCRIPTION OF DRAWINGS

A detailed description of preferred embodiments of the present invention follows, with reference to the attached drawing, wherein

FIG. 1 schematically illustrates a system in accordance with the present invention.

### DETAILED DESCRIPTION

The invention relates to a sulfur resistant catalyst and hydrotreating method utilizing such catalyst wherein the catalyst maintains resistance to sulfur at high temperatures and for extended periods of time operating in gas and in liquid phase.

It is desirable to provide a catalyst and hydrotreating method wherein the catalyst maintains activity at high temperatures, for example in the range of about 500° K and about 730° K, typically about 650° K. One particular example of such a process is a hydrotreatment process following hydrodesulfurization and hot separation whereby a gas phase is produced which is a good candidate for further hydrotreatment. One particular form of hot separation is as disclosed in a co-pending patent application by the present inventors wherein a gas phase is produced from a vacuum gas oil (VGO) feed which gas phase contains a Diesel feed fraction, as well as hydrogen, naphtha, vacuum gas oil, C₁-C₄ hydrocarbons, H₂S and NH₃. The Diesel feed fraction typical in this gas phase is a desirable fraction, but needs an increase in Cetane number before it can be incorporated into the Diesel pool for sale and use.

The present invention provides a catalyst and hydrotreatment method which are ideal for use in the high pressure and high temperature conditions and sulfur-containing feeds encountered in such processes.

In accordance with the present invention, a catalyst is provided which includes a base preferably selected from the group consisting of alumina, aluminosilicate, aluminotitanate and combinations thereof, and further provided with at least one metal selected from the group consisting of nickel, tungsten, molybdenum, palladium, phosphorous, titanium and mixtures thereof. Several examples of catalysts within the scope of the present invention are described further in Table 1 below.

TABLE 1

| | Catalyst | | |
|---|---|---|---|
| | A | B | C |
| Type | | | |
| Physical Composition | Ni/W | W/Ni/Pd | Mo/Ni/P |
| Base | Y Zeolite | Si/Al | Alumina |
| Surface sq m/g | 150 | 171 | 120 |
| pore volume cu cm/g | 0.44 | 0.39 | 0.51 |
| V mesopores/V total pores* | 0.17 | 0.21 | 0.22 |
| Chemical Properties wt % | | | |
| Ni | 1.3 | 2.2 | 1.8 |
| W | 7.7 | 3.0 | 0 |
| P | 0 | 0 | 1.5 |
| Mo | 0 | 0 | 4.6 |
| Pd | 0 | 0.2 | 0 |
| Si0₂/Al₂O₃ (total) mol | 9.3 | 7.5 | 0 |
| Si0₂/Al₂O₃ infrared mol | 11.0 | 18 | 0 |
| Oxygen adsorption mmol/g | 0.4 | 0.63 | 0.55 |
| Amine desorption 300° C. mmol/g | 0.2 | 0.24 | 0.1 |
| Amine desorption 500° C. mmol/g | 0.09 | 0.04 | 0.05 |

*mesopores (dp 30-150 Å)

As shown, the catalyst of the present invention preferably has a surface area of between about 100 and 175 m²/g, a pore volume of between about 0.3 and about 0.6 m³/g and a ratio of mesopore pore volume to total pore volume of between about 0.1 and about 0.3. As used herein the term mesopore is used to refer to pores having a pore diameter of between about 30 and 150 Angstroms.

The catalyst in accordance with the present invention has advantageously been found to possess an oxygen adsorption capacity of between about 0.3 and about 0.8 mmol/g at 300° C., an amine absorption capacity at room temperature of between about 0.3 and about 0.5 mmol/g, an amine desorption capacity at 300° C. of between about 0.2 and 0.45 and an amine desorption capacity at 500° C. of between about 0.02 and about 0.1 mmol/g.

The catalyst characterized as set forth above advantageously possesses excellent resistance to deactivation from sulfur and other contaminants, even at temperatures exceeding 650° K for extended periods of time. This is particularly advantageous as compared to activity of a conventional catalyst under similar conditions. The catalyst is well suited toward selectively encouraging Cetane Index improving reactions such as aromatic saturating reactions and reactions which open naphthene rings to form alkyl paraffins.

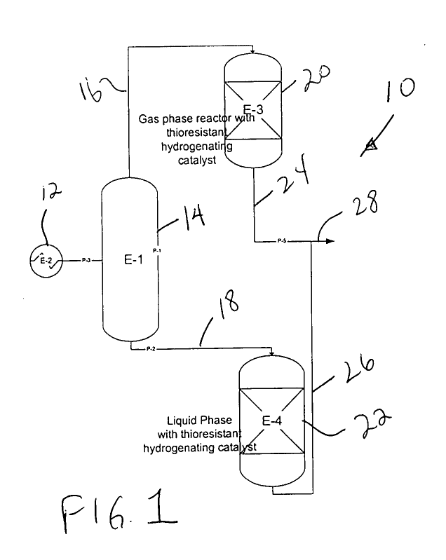

Turning now to FIG. 1, a system and method in accordance with the present invention is further illustrated. FIG. 1 shows a system 10 wherein feedstock 12 is fed to a hot separator system 14 to generate a gas phase 16 and a liquid phase 18. Gas phase 16 is fed to a gas phase reactor 20 containing the catalyst of the present invention and liquid phase 18 is fed to a liquid phase reactor 22 containing catalyst of the present invention. Products 24, 26 are then combined to provide final product 28 having the desired improved properties.

When using the system of FIG. 1, the gas phase will contain about 5-50 psig partial pressure of H₂ S, and about 0.1-5 psig partial pressure of NH₃. A total system pressure is advanegeously between about 500 and about 1500 psig, with between about 300 and about 1300 psig hydrogen partial pressure. Temperature is preferably between 340° C. and about 420° C.

Table 2 below sets forth a comparison between a catalyst of the present invention and a conventional catalyst. Both catalysts are utilized during a hydrotreatment process of a feed having 5% wt. naptha, 80% wt. Diesel and 15% wt. LVGO, which contains 2% wt. sulfur, 0.1% wt. nitrogen, 54% wt. aromatics and has a Diesel Cetane number of 35, at conditions as listed below in Table 2.

TABLE 2

| Catalysts Activity | Conventional | Thioresistant |
|---|---|---|
| Temperature ° K | 650 | 650 |
| LHSV (h − 1) | 0.8 | 0.8 |
| H₂ partial pressure | 1050 | 1050 |
| psig | | |
| H₂S partial pressure | 5/50 | 5/50 |
| psig | | |
| NH₃ partial pressure psig | 0.1/2 | 0.1/2 |
| Naphtha HDS wt % | 95/85 | 92/90 |
| Diesel HDS wt % | 92/85 | 90/88 |
| Aromatic reduction wt % | 60/40 | 65/60 |
| Delta Cetane Index wt % | 10/6 | 14/11 |
| Delta LVGO wt % | 15/10 | 30/25 |

Table 2 shows two values of hydrogen sulfide partial pressure in the gas phase reactor, one at 5 psig and the other 50 psig of partial pressure, and all at the same total pressure, at the start of the run.

By comparing the second column (conventional) to the third column (thioresistant), it can be seen that hydrodesulfurization in naphtha produced fell from 95% to 85% wt. with the conventional catalyst, while hydrodesulfurization with the thioresistant catalyst fell from 92% only to 90% wt.

Diesel hydrodesulfurization fell from 92% to 85% wt. with the conventional catalyst but only fell from 90% to 88% wt. when using the thioresistant catalyst of the present invention.

A main benefit of the present invention can be seen in the hydrogenating capabilities where aromatic reduction was achieved at 60% and 40% respectively with the conventional catalyst, but were advantageously achieved at 65% and 60% wt. respectively with the thioresistant catalyst of the present invention.

This translated to a cetane number modification of 10 and 6 respectively using the conventional catalyst and 14 and 11 respectively using the thioresistant catalyst of the present invention.

These benefits are those which were targeted when developing the catalyst of the present invention. In addition, The thioresistant catalyst of the present invention also provides a better conversion of LVGO, 30% wt. as compared to 15% wt., and also provides better stability in the presence of H₂S and NH₃.

As shown, at the high temperature conditions of the hydrotreatment process used, although the conventional catalyst begins with comparable or even slightly better properties, these properties quickly reduce to levels significantly lower than the long-term activity of the catalyst of the present invention.

Table 2 shows these values for the start of run (SOR) and end of run (EOR), which was taken in this case to be after 180 days continuous use at the listed conditions. Significantly, the conventional catalyst started with a Cetane number improvement of 10, but after 180 days on stream, had reduced to an increase of only 6. In comparison, the catalyst of the present invention started with an increase of 11, and still had an increase of 10 after 180 days on stream.

Table 3 below shows catalyst deactivation when operating at 650° K at LHSV of 0.8⁻¹, a hydrogen partial pressure of 1050 psig and H₂S partial pressure of 50 psig.

TABLE 3
deativation of catalyst
(Feed 5% Naphtha + 80% Diesel + 15% LVGO)
Suphur 2 wt % Nitrogen 0.1 wt %
Aromatics 54 wt % Cetane in Diesel: 35

| | Conventional catalyst | Thioresistant catalyst |
|---|---|---|
| Operating Conditions | Start of run/180 days | Start of run/180 days |
| Temperature ° K | 650 | 650 |
| H2 partial pressure psig | 1050 | 1050 |
| H2S partial pressure psig | 100 | 100 |
| H3N partial pressure psig | 2.5 | 2.5 |
| Naphtha HDS wt % | 82/66 | 88/80 |
| Diesel HDS wt % | 83/70 | 85/79 |
| Aromatics reduction | 45/35 | 59/50 |
| wt % | | |
| Delta cetane Index | 7/5 | 11/10 |
| Conversion of LVGO | 10/6 | 27/23 |
| wt % | | |

Other activity of the catalyst of the present invention also remained higher with the catalyst of the present invention, such as naphtha hydrodesulfurization, Diesel hydrodesulfurization, aromatic reduction and VGO conversion rates. Thus, the catalyst of the present invention has excellent hydrotreatment activity and is resistant to sulfur deactivating for extended use at high temperature.

Table 3 shows the value for start of run, where both catalysts had equivalent sulfur removal capability, with the thioresistant catalyst having more hydrogenating capacity. After operating for 180 days it can be seen that most desulfurization capability in the convetional catalyst is gone, probably due to the high operating temperature and the presence of H₂S and NH₃ in the gas. The thioresistant catalyst of the present invention, however, has kept most of its properties at reasonable values. Notably, the hydrogenation of aromatics, Cetane number properties and LVGO conversion capabilities remained substantially constant. This is a particular advantage of the present invention.

Table 4 below sets forth results using the process scheme as illustrated in FIG. 1 as described above. In this scheme the thioresistant catalyst of the present invention is tested against a conventional catalyst with a conventional trickle bed operation (HDS), and operating at the same amount of catalyst and process conditions.

TABLE 4
(Feed 5% Naphtha + 80% Diesel + 15% LVGO)
Suphur 2 wt % Nitrogen 0.1 wt %
Aromatics 54 wt % Cetane in Diesel: 35

| | Conventional | Thioresistant |
|---|---|---|
| | catalyst | catalyst |
| Operating Conditions | Trickle bed | Gas Phase/Liquid Phase |
| Hot separator temperature ° K | — | 650 |
| Pressure Hot separator Psig | — | 900 |
| Temperature ° K reactors | 650 | 650 |
| H2 partial pressure psig | 750 | 750 (gas phase) |
| H2S partial pressure psig | 50 | 50 (gas phase) |
| NH₃ partial pressure psig | 1.5 | 1.5 gas phase |
| Products | Trickle bed | Gas and liquid Phase |
| Naphtha HDS wt % | 68 | 76 |
| Diesel HDS wt % | 65 | 73 |
| Aromatics reduction wt % | 37 | 50 |
| Delta cetane Index | 4 | 8 |
| Conversion of LVGO wt % | 9 | 17 |
| Yield on diesel wt % | 80 | 85 |
| NOx emission mgphp | 123 | 88 |

Table 4 shows 76% wt. of naphtha HDS and 73% wt. of Diesel HDS, while also exhibiting a 50% wt. reduction of aromatics. The conventional catalyst was out performed in each of these instances.

It is clear from these results that the thioresistant catalyst of the present invention performs well at high temperatures and in the presence of high H₂S and any NH₃ partial pressures, and that this performance provides an advantage in the hydrogenation and conversion reactions, as indicated by the improved cetane and aromatic content in the product. The yield of Diesel was increased through improved LVGO conversion, and the NOₓ emission as performed on a 1998 Detroit Diesel engine at 2000 rpm and 30 HP load shows significant improvement in terms of NOₓ emission.

The hydrotreatment method in accordance with the present invention may suitably be carried out at conditions as follows.

Temperature is preferably between about 370° and about 420° C., hydrogen partial pressure is preferably between about 500 and about 1500 psig, H₂S partial pressure is preferably between about 1 and about 250 psig, and NH₃ partial pressure is preferably between of about 0.1 and about 10 psig.

The catalyst and method according to the present invention, when utilized in the foregoing process conditions, especially at a partial pressure of H₂S between about 5 and 50 psig, a partial pressure of NH₃ of between 0.1 and about 5 psig and for a period of about 180 days, advantageously provides cetane number improvement of between about 5 and 12 numbers for the entire cycle length. Hydrodesulfurization is provided at a rate of between about 50 and about 99% wt. for the entire cycle length. Nitrogen removal under these conditions is advantageously between about 40 and about 90% wt. for the entire cycle length. Aromatics reductions under such conditions is advantageously between about 40 and about 70% wt. during the entire cycle length. Conversion of LVGO, under these conditions is advantegously between about 20 and 40% during the entire cycle length as well. At the start of run for these properties, the catalyst in accordance with the present invention may advantageously exhibit a start of run cetane index modification of about 10-15 numbers, desulfurization of between about 60 and 99% wt., and nitrogen removal of between about 40% and about 80% wt.

The feedstock to a hydrotreatment method in accordance with the present invention may suitably be any feedstock containing a hydrocarbon fraction which can advantageously be treated in a hydrotreatment process. One example of a particularly desirable feedstock for such a process is a feedstock including a Diesel feed fraction which is desirable to be upgraded to provide a higher Cetane Index or number, and further wherein the feedstock contains at least a substantial amount of sulfur. The sulfur may be in the form of H₂S and/or in other forms or compounds.

The feedstock is preferably fed to a reactor containing catalyst as described above and operated at suitable hydrotreatment conditions, and the product stream includes an upgraded Diesel product having desirably improved Cetane Index, and also having substantially reduced sulfur content.

The catalyst of the present invention advantageously maintains the desirable activity even after extended exposure and use in sulfurous conditions and at high temperature. In use, the catalyst of the present invention typically has a start of run activity and an end of run activity, wherein the end of run activity is defined as activity toward a particular reaction after use of the catalyst in hydrotreating conditions while exposed to a feed containing between about 0.05 and about 2.5% wt. of sulfur, aromatics between about 30 and about 70% wt., and cetane number between about 30 and about 43. Advantageously the catalyst of the present invention maintains activity in connection with delta Cetane Index, aromatic reduction, and HDS for naphtha and Diesel for at least about 180 days from start up.

It should be readily appreciated that a hydrotreatment method and catalyst have been provided in accordance with the present invention wherein Diesel fractions can advantageously be treated so as to upgrade the cetane number while also reducing sulfur contamination wherein the catalyst has excellent resistance to sulfur deactivation. This invention may be embodied in other forms or carried out in other ways without departing from the spirit or essential characteristics thereof. The present embodiment is therefore to be considered as in all respects illustrative and not restrictive, the scope of the invention being indicated by the appended claims, and all changes which come within the meaning and range of equivalency are intended to be embraced therein.

1. A method for hydrotreating a Diesel feedstock, comprising the steps of:
providing a feedstock containing a Diesel feed fraction and sulfur;
and feeding said feedstock to a hydrotreating reactor containing a catalyst selective toward Cetane Index improving reactions and hydrodesulfurization reactions so as to provide a product stream containing an improved Diesel fraction having an increased Cetane Index as compared to said Diesel Feed fraction, wherein said catalyst is substantially resistant to sulfur deactivation.

2. The method of claim 1, wherein said feeding step comprises feeding said feedstock to a hot separator system to provide a gas phase and a liquid phase, feeding said gas phase to a gas phase reactor containing said catalyst, feeding said liquid phase to a liquid phase reactor containing said catalyst, and combining product from said gas phase reactor and said liquid phase reactor so as to provide said product stream.

3. The method of claim 1, wherein said catalyst has a start of run Cetane Index activity and an end of run Cetane Index activity defined as activity increasing Cetane Index after use of said catalyst in hydrotreating conditions exposed to H₂ S partial pressure of at least about 5 psig and for at least about 180 days, and wherein said end of run Cetane Index activity produces a Cetane number improvement of at least 5.

4. The method of claim 1, wherein said catalyst has a start of run hydrodesulfurization activity and an end of run hydrodesulfurization activity defined as activity in hydrotreating conditions exposed to H₂S partial pressure of at least about 5 psig and NH₃ partial pressure of at least about 0.1 psig for a period of at least 180 days, and wherein said end of run hydrodesulfurization activity is at least about 50% wt.

5. The method of claim 1, wherein said catalyst has a start of run nitrogen removal activity and an end of run nitrogen removal activity defined as activity in hydrotreating conditions exposed to H₂S partial pressure of at least about 5 psig and NH₃ partial pressure of at least about 0.1 psig for a period of at least 180 days, and wherein said end of run nitrogen removal activity is at least 40% wt.

6. The method of claim 1, wherein said catalyst has a start of run aromatic reduction activity and end of run aromatic reduction activity defined as activity in hydrotreating conditions exposed to H₂S partial pressure of at least about 5 psig and NH₃ partial pressure of at least about 0.1 psig for a period of at least 180 days, and wherein said end of run aromatic reduction activity is at least 40% wt.

7. The method of claim 1, wherein said catalyst has a start of run LVGO conversion activity and an end of run LVGO conversion activity defined as activity in hydrotreating conditions exposed to H₂S partial pressure of at least about 5 psig and NH₃ partial pressure of at least about 0.1 psig for a period of at least 180 days, and wherein said end of run LVGO conversion activity is at least 20% wt.

8. The method of claim 1, wherein said catalyst comprises a base selected from the group consisting of alumina, aluminosilicate, aluminotitanate and combinations thereof, and at least one metal selected from the group consisting of nickel, tungsten, molybdenum, palladium, phosphorous, titanium and mixtures thereof.

9. The method of claim 1, wherein said catalyst has a surface area of between about 100 and about 175 m²/g, a pore volume of between about 0.3 and about 0.6 m³/g and a ratio of mesopore pore volume to total pore volume of between about 0.1 and about 0.3.

10. The method of claim 1, wherein said catalyst has an oxygen adsorption capacity of between about 0.3 and about 0.8 mmol/g at 300° C., an amine absorption capacity at room temperature of between about 0.3 and about 0.5 mmol/g, an amine desorption capacity at 300° C. of between about 0.2 and about 0.45 mmol/g, and an amine desorption capacity at 500° C. of between about 0.02 and about 0.1 mmol/g.

11. The method of claim 2, wherein said gas phase contains hydrogen, naphtha, Diesel, light vacuum gas oil, C₁-C₄ hydrocarbons, H₂S and NH₃.

12. A sulfur resistant catalyst, comprising a base selected from the group consisting of alumina, aluminosilicate, aluminotitanate and combinations thereof, and at least one metal selected from the group consisting of nickel, tungsten, molybdenum, palladium, phosphorous, titanium and mixtures thereof, wherein said catalyst is substantially resistant to sulfur deactivation.

13. The catalyst of claim 12, wherein said catalyst has a start of run Cetane Index activity and an end of run Cetane Index activity defined as activity increasing Cetane Index after use of said catalyst in hydrotreating conditions exposed to H₂ S partial pressure of at least about 5 psig and for at least about 180 days, and wherein said end of run Cetane Index activity produces a Cetane number improvement of at least 5.

14. The catalyst of claim 12, wherein said catalyst has a start of run hydrodesulfurization activity and an end of run hydrodesulfurization activity defined as activity in hydrotreating conditions exposed to H₂S partial pressure of at least about 5 psig and NH₃ partial pressure of at least about 0.1 psig for a period of at least 180 days, and wherein said end of run hydrodesulfurization activity is at least about 50% wt.

15. The catalyst of claim 12, wherein said catalyst has a start of run nitrogen removal activity and an end of run nitrogen removal activity defined as activity in hydrotreating conditions exposed to H₂S partial pressure of at least about 5 psig and NH₃ partial pressure of at least about 0.1 psig for a period of at least 180 days, and wherein said end of run nitrogen removal activity is at least 40% wt.

16. The catalyst of claim 12, wherein said catalyst has a start of run aromatic reduction activity and end of run aromatic reduction activity defined as activity in hydrotreating conditions exposed to H₂S partial pressure of at least about 5 psig and NH₃ partial pressure of at least about 0.1 psig for a period of at least 180 days, and wherein said end of run aromatic reduction activity is at least 40% wt.

17. The catalyst of claim 12, wherein said catalyst has a start of run LVGO conversion activity and an end of run LVGO conversion activity defined as activity in hydrotreating conditions exposed to H₂S partial pressure of at least about 5 psig and NH₃ partial pressure of at least about 0.1 psig for a period of at least 180 days, and wherein said end of run LVGO conversion activity is at least 20% wt.

18. The catalyst of claim 12, wherein said catalyst has a surface area of between about 100 and about 175 m²/g, a pure volume of between about 0.3 and about 0.6 m³/g and a ratio of mesopore pure volume to total pure volume of between about 0.1 and about 0.3.

19. The catalyst of claim 12, wherein said catalyst has an oxygen adsorption capacity of between about 0.3 and about 0.8 mmol/g at 300° C., an amine absorption capacity at room temperature of between about 0.3 and about 0.5 mmol/g, an amine desorption capacity at 300° C. of between about 0.2 and about 0.45 mmol/g, and an amine desorption capacity at 500° C. of between about 0.02 and about 0.1 mmol/g.
